(19) United States
(12) Patent Application Publication
(10) Pub. No.: US 2005/0114836 A1
(43) Pub. Date: May 26, 2005

(54) Block box testing in multi-tier application environments

(76) Inventor: Jennifer Fu, Cupertino, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/721,708

(22) Filed: Nov. 24, 2003

(51) Int. Cl. G06F 9/44

(52) U.S. Cl. 717/124

(57) ABSTRACT

A method of block box testing in multi-tier application environments. A multi-tier application is divided into a plurality of tier-specific modules. Each of the plurality of tier-specific modules is tested as a black box. Output from testing a tier-specific module can be stored in a computer usable media. Output from a first tier-specific module of the plurality of tier-specific modules can be used as input to a subsequent tier-specific module. Absent actual output, simulated input can used to test tier-specific modules.

### TECHNICAL FIELD

Embodiments of the present invention relate to block box testing in multi-tier application environments.

### BACKGROUND ART

An important portion of a software development process is the testing of the software. Testing normally occurs in several phases, for example, engineering test, development test, alpha testing and beta testing. Such testing helps to ensure that a software product meets its requirements, including functioning in the target hardware and software environment.

An important testing methodology is known as “black box” testing. Black box testing is also known as functional testing. Black box software testing is a method of evaluating software wherein the internal workings of the item under test are not known by the tester. For example, a tester knows only a list of input stimuli and the expected outcomes (or outputs) corresponding to the inputs. In general, a tester does not know how the program arrives at those outputs. Black box testing is often used for software quality assurance.

Black box testing has a number of advantages over other forms or types of testing. In general, a black box test is considered to be unbiased because the designer and the tester can operate independently. In addition, the tester does not need specific knowledge of any development tools and/or design expertise. For example, a black box software tester does not need to understand the software programming language used to create the software under test. Additional benefits typically include that the test is performed from a user perspective, and that test cases can be designed and created as soon as the specifications are complete, typically long before the software is complete. Further, black box testing tests an implementation relative to its specification, rather than testing how well an actual implementation performs.

Unfortunately, black box testing is generally not applicable until the very last stages of a project when the software is deemed complete by the developers. Thus, there is often little time available in a schedule to correct any problems identified by the testing. Such a “last minute” nature of black box testing is especially burdensome for multi-tier software. To utilize black box testing on multi-tier software would generally require that all tiers are available prior to testing. As different tiers frequently become available at different times throughout a project, waiting until all tiers are complete is an inefficient use of resources.

Thus a need exists for block box testing in multi-tier application environments. A further need exists for block box testing in multi-tier application environments which enables testing of individual tiers. A still further need exists to meet the previously identified needs in a manner that is complimentary and compatible with conventional computer system testing systems and processes.

### SUMMARY OF THE INVENTION

Embodiments of the present invention provide for block box testing in multi-tier application environments. Further embodiments of the present invention provide block box testing in multi-tier application environments which enables testing individual tiers. Still further embodiments of the present invention meet the previously identified need in a manner that is complimentary and compatible with conventional computer system testing systems and processes.

A method of block box testing in multi-tier application environments is disclosed. A multi-tier application is divided into a plurality of tier-specific modules. Each of the plurality of tier-specific modules is tested as a black box. Output from testing a tier-specific module can be stored in a computer usable media. Output from a first tier-specific module of the plurality of tier-specific modules can be used as input to a subsequent tier-specific module. Absent actual output, simulated input can used to test tier-specific modules.

### BRIEF DESCRIPTION OF THE DRAWINGS

FIG. 1 illustrates a utility data center which may form a platform for multi-tier applications, in accordance with embodiments of the present invention.

FIG. 2 illustrates a multi-tier application designed to operate across multiple tiers of a utility data center, in accordance with embodiments of the present invention.

FIG. 3 illustrates a method of block box testing in multi-tier application environments, in accordance with embodiments of the present invention.

FIG. 4 illustrates a flow chart for a method of block box testing in multi-tier application environments, in accordance with embodiments of the present invention.

### BEST MODES FOR CARRYING OUT THE INVENTION

In the following detailed description of the present invention, block box testing in multi-tier application environments, numerous specific details are set forth in order to provide a thorough understanding of the present invention. However, it will be recognized by one skilled in the art that the present invention may be practiced without these specific details or with equivalents thereof. In other instances, well-known methods, procedures, components, and circuits have not been described in detail as not to unnecessarily obscure aspects of the present invention.

### Notation and Nomenclature

Some portions of the detailed descriptions which follow (e.g., process 400) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “storing” or “dividing” or “computing” or “testing” or “calculating” or “determining” or “storing” or “displaying” or “recognizing” or “generating” or “performing” or “comparing” or “synchronizing” or “accessing” or “retrieving” or “conveying” or “sending” or “resuming” or “installing” or “gathering” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Block Box Testing in Multi-Tier Application Environments

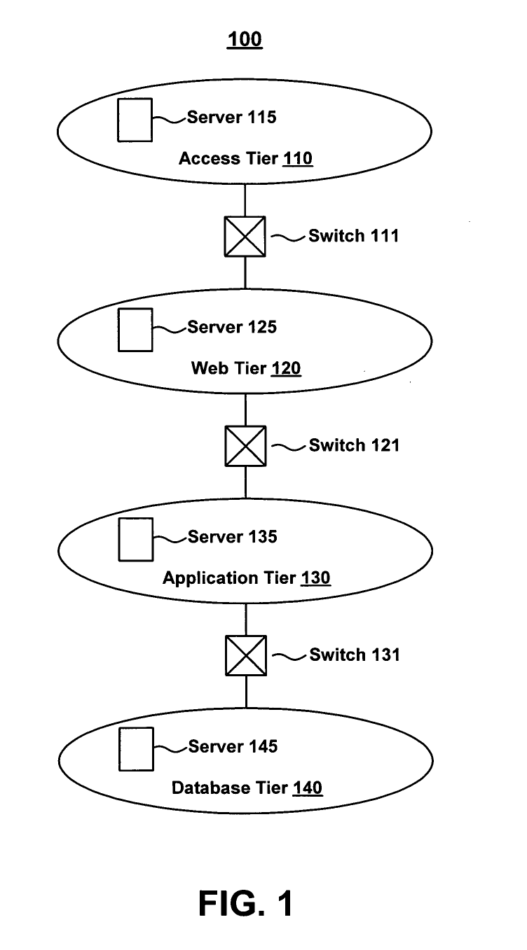

FIG. 1 illustrates a utility data center 100 which may form a platform for multi-tier applications, in accordance with embodiments of the present invention. Utility data center 100 comprises four tiers, an access tier 110, a web tier 120, an application tier 130 and a database tier 140.

The database tier 140 is generally populated with a variety of storage devices and architectures, including storage area networks (SAN). Streaming tape, different categories of redundant array of independent disks (RAID), various snapshot technologies and storage appliances can be used to populate database tier 140.

High speed switches, e.g., switch 131, link the database tier 140 to the application tier 130. This linking enables processing to be linked to data in a flexible, dynamic manner. Some application software can be installed at this layer, for example, enterprise resource planning (ERP) core systems. In general, most user applications, for example web services, execute on the application tier 130.

Similarly, high speed switches, e.g., switch 121, link the application tier 130 to the web tier 120. Access to applications is managed uniformly with standard markup languages such as hypertext markup language (HTML) and extensible markup language (XML). Generally, network attached storage (NAS) appliances assist in the storage and caching of data for the application layer.

Web tier 120 comprises additional servers and storage to allow users to browse Web pages containing the information that they need. High speed switches, e.g., switch 111, link the web tier 120 with access tier 110. The access layer is where basic security functionality resides. For example, the data center side of virtual private networks (VPNs), authentication and authorization repositories and intrusion detection systems reside in the access tier 110.

While a utility data center offers great flexibility and efficiency, provisioning resources and executing an application within such a utility data center is highly complex. For example, an application appearing as a single session to a user generally involves different software operating on different server computer systems, e.g., servers 115, 125, 135 and 145, in the different tiers.

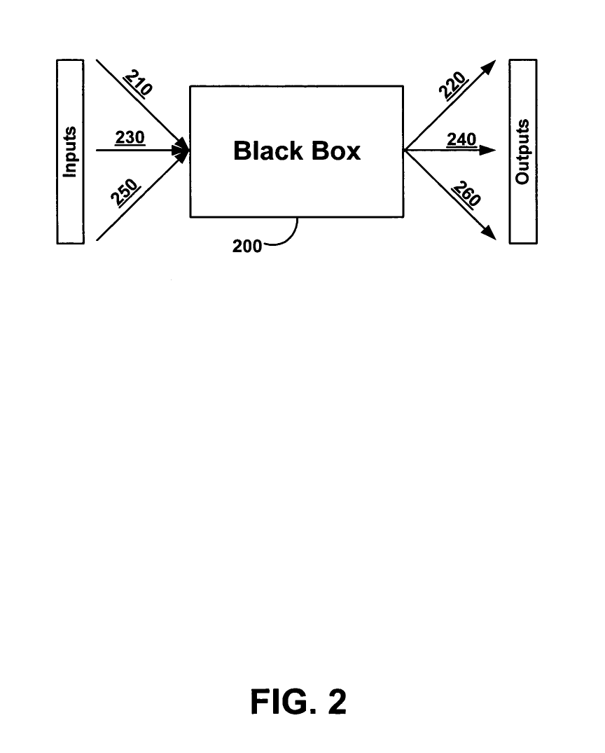

Referring now to FIG. 2, consider a multi-tier application 200 designed to operate across multiple tiers of a utility data center, e.g., utility data center 100 of FIG. 1, in accordance with embodiments of the present invention. In conventional black box testing, application 200 would be tested as a whole. For example, a design specification would give expected outputs 220, 240 and 260 in response to inputs 210, 230 and 250. A conventional black box testing process would apply the inputs 210, 230 and/or 250 to the application 200 and determine if the correct outputs (22, 240, 260) were obtained.

However, as discussed previously, this conventional black box testing cannot be conducted until the entire application 200 is available for testing. Application 200 typically comprises a plurality of modules that operate on different tiers. It is usually the case that such different modules are developed at different times by different groups of developers. Consequently, much work, both on the individual modules and on integrating them into the whole application 200 must be completed prior to the availability of application 200 for black box testing. It is to be further appreciated that any problems found in such testing are not immediately isolated by the test process to a failing module. Rather, only the entire application in known to be deficient.

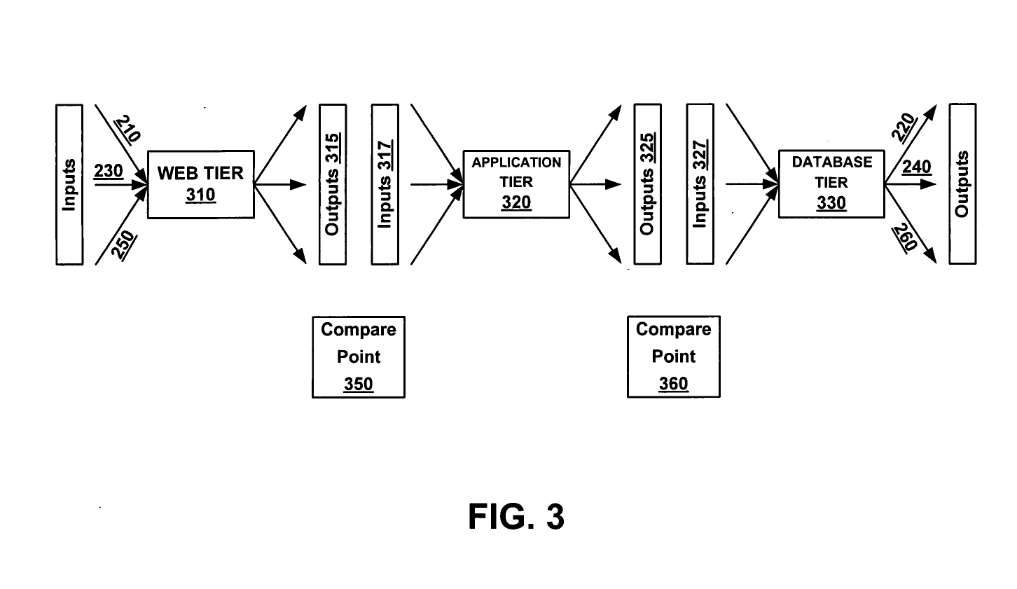

FIG. 3 is an exemplary illustration of a novel method of block box testing in multi-tier application environments, in accordance with embodiments of the present invention. Multi-tier application 200 (FIG. 2) has been divided into separate modules 310, 320 and 330. Module 310 operates on a web tier, e.g., web tier 120 of FIG. 1. Module 320 operates on an application tier, e.g., application tier 130 of FIG. 1. Module 330 operates on a database tier, e.g., database tier 140 of FIG. 1. It is to be appreciated that embodiments in accordance with the present invention are well suited to dividing an application into greater or fewer modules.

Inputs 210, 230 and 250 (FIG. 2) are applied to web tier module 310, in a similar fashion as to the application of inputs 210, 230 and 250 to application 200 (FIG. 2). In contrast to conventional black box testing however, outputs 315 of web tier module 310 are observed rather than outputs of the entire application 200. Outputs of tier-specific modules, e.g., web tier module 310, are generally computer readable information, e.g., XML files and/or database files. Outputs 315 of web tier module 310 can then be used as inputs 317 to application tier module 320. Outputs 315 can be stored in a computer usable media, for example on a test server, e.g., for documentation of testing. It is appreciated that outputs 315 and inputs 317 are identically equal. Outputs 315 can also be stored for future use and inputs to a subsequent test, e.g., if application tier module 320 is not available for testing at the same time.

Likewise, application tier module 320 produces outputs 325 in response to inputs 317. It is appreciated that outputs 325 and 315 are not seen by a user of application 200 and were heretofore unseen in a black box testing process. Outputs 325 of application tier module 320 are then used as inputs 327 to database tier module 330. Again, it is appreciated that outputs 325 and inputs 327 are identically equal.

Database tier 330 is tested using inputs 327 to stimulate outputs 220, 240 and 260. It is appreciated that 220, 240 and 260 are the expected response to inputs 210, 230 and 250 applied to the entire application 200 in FIG. 2. In this novel manner, tier-specific modules are tested independently. Beneficially, failures can be isolated to tier-specific modules prior to integration into a final application. An additional advantage is that the tier-specific modules can be tested in any order, e.g., as they become available from the developers, rather than having to wait until the entire application has been integrated. For example, if application tier module 320 is ready prior to the availability of web tier module 310, application tier module 320 can be tested using simulated inputs data, rather than actual output from web tier module 310.

When testing a combination of tier-specific modules, for example testing web tier module 310 and application tier module 320, the output of the first module, e.g., web tier module 310 should be compared to the input specifications for the next module, e.g., application tier module 320. For example, if application tier module 320 is designed to accept a particular input range, input outside of that range will generally produce erroneous outputs. Generally, a tier-specific module should not be stimulated with inputs outside of its input specification. Such stimulation may produce false error indications, e.g., incorrectly indicate that the module is not functioning. Comparisons of module output to subsequent module input can take place at compare points 350 and 360 in FIG. 3.

If an output from a first module does not meet input requirements for a subsequent module, this may indicate a failure of the first module. Alternatively, there may be a specification mismatch in the design of the two modules. Advantageously, embodiments in accordance with the present invention enable such problems to be identified more readily than with conventional black box testing.

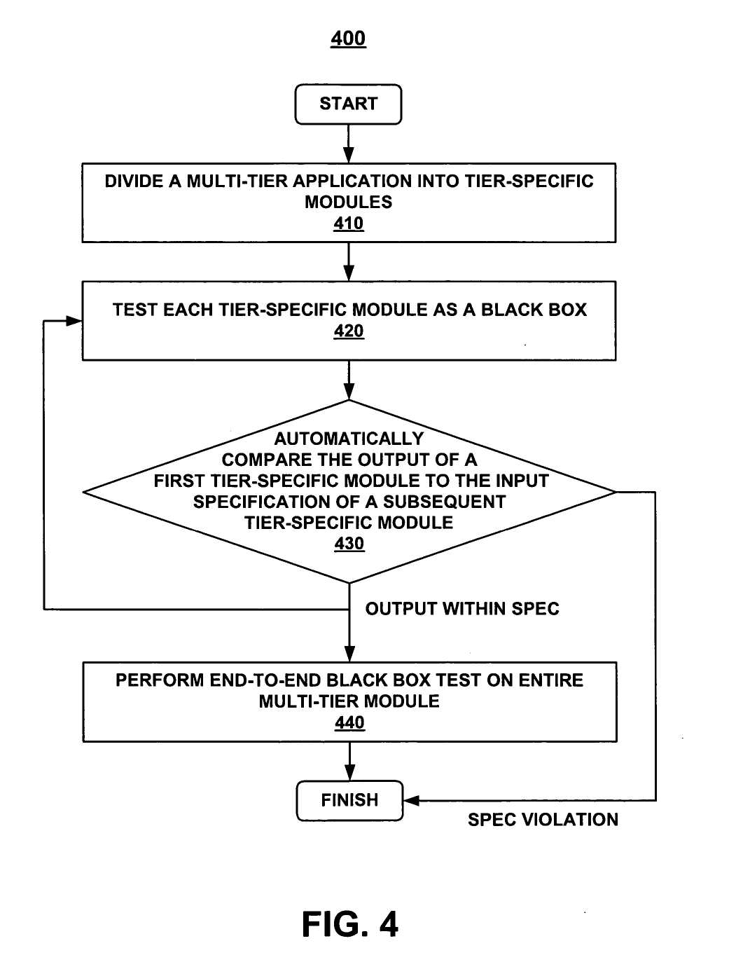

FIG. 4 illustrates a flow chart for a method 400 of block box testing in multi-tier application environments, in accordance with embodiments of the present invention. In block 410, a multi-tier application, e.g., application 200 of FIG. 2 is divided into tier-specific modules, e.g., tier-specific modules 310, 320 and 330 of FIG. 3. Generally, the tier-specific modules operate within a specific tier, e.g., a database tier 140 of FIG. 1.

In block 420, each tier-specific module is tested as a black box. It is appreciated that output from a previous tier-specific module can be used as input for a subsequent tier-specific module. In the absence of output from a previous tier-specific module, simulated input may be used to drive a tier-specific module.

In optional block 430, the output of a first tier-specific module is automatically compared to the input specification of a subsequent tier-specific module. If the output is within the input specification of the subsequent tier-specific module, testing can proceed. If the output is not within the input specification of the subsequent tier-specific module, then testing of the particular arrangement of multi-tier modules is halted and the reasons for the mismatch, e.g., error in the first module and/or specification deficiency, are investigated. It is to be appreciated that such an investigation is generally performed by a development team.

It is to be further appreciated that testing of other tier-specific modules can beneficially continue after an error is found in one module and/or a specification discrepancy is found between modules. For example, if an output from a first tier-specific module is found not to match the input requirements of a subsequent tier-specific module, testing of the subsequent tier-specific module can continue. Advantageously, the subsequent tier-specific module can be stimulated with simulated input, and its output can be used as input to another tier-specific module.

Responsive to the comparison of block 430, if the output of the first tier-specific module is within the input specification of the subsequent tier-specific module, then testing can continue at block 420.

In optional block 440, a conventional end-to-end black box test is performed on the entire multi-tier application, e.g., multi-tier application 200 of FIG. 2. Performing such a test serves as a final check of the integration of the tier-specific modules and that the entire application meets its requirements.

Embodiments of the present invention provide for block box testing in multi-tier application environments. Further embodiments of the present invention provide block box testing in multi-tier application environments which enables reinstallation test systems and rebooting of operating systems during testing. Still further embodiments of the present invention meet the previously identified need in a manner that is complimentary and compatible with conventional computer system testing systems and processes.

Embodiments in accordance with the present invention, block box testing in multi-tier application environments, are thus described. While the present invention has been described in particular embodiments, it should be appreciated that the present invention should not be construed as limited by such embodiments, but rather construed according to the below claims.

1. A method of block box testing in a multi-tier application environment comprising:
dividing a multi-tier application into a plurality of tier-specific modules; and
testing each of said plurality of tier-specific modules as a black box.

2. The method of claim 1 wherein an output from a first tier-specific module of said plurality of tier-specific modules is used as input to a subsequent tier-specific module of said plurality of tier-specific modules.

3. The method of claim 2 wherein said output is stored in a computer usable media prior to use as said input.

4. The method of claim 2 wherein said output is stored, prior to said use as said input, for a period of time substantially greater than a time that said output is stored during use of said multi-tier application.

5. The method of claim 2 further comprising:
automatically comparing an output of said first tier-specific module to an input specification of said subsequent tier-specific module;
continuing said testing if said output meets said input specification; and
halting said testing if said output does not meet said input specification.

6. The method of claim 1 wherein at least one of said plurality of tier-specific modules is tested prior to availability of a preceding tier-specific module.

7. The method of claim 6 wherein simulated input is used to test said at least one of said plurality of tier-specific modules.

8. The method of claim 1 further comprising performing an end-to-end black box test on said multi-tier application.

9. The method of claim 1 wherein said multi-tier application environment comprises a utility data center.

10. The method of claim 1 wherein each of said plurality of tier-specific modules executes within a single tier of said multi-tier application environment.

11. A computer readable media comprising computer usable instructions that when executed on a computer system implement a method of block box testing in a multi-tier application environment, said method comprising:
accessing a plurality of tier-specific modules that comprise a multi-tier application; and
testing each of said plurality of tier-specific modules as a black box.

12. The computer readable media of claim 1 1 wherein an output from a first tier-specific module of said plurality of tier-specific modules is used as input to a subsequent tier-specific module of said plurality of tier-specific modules.

13. The computer readable media of claim 12 wherein said output is stored in a computer usable media prior to use as said input.

14. The computer readable media of claim 12 wherein said output is stored, prior to said use as said input, for a period of time substantially greater than a time that said output is stored during use of said multi-tier application.

15. The computer readable media of claim 12 further comprising:
automatically comparing an output of said first tier-specific module to an input specification of said subsequent tier-specific module;
continuing said testing if said output meets said input specification; and
halting said testing if said output does not meet said input specification.

16. The computer readable media of claim 11 wherein at least one of said plurality of tier-specific modules is tested prior to availability of a preceding tier-specific module.

17. The computer readable media of claim 16 wherein simulated input is used to test said at least one of said plurality of tier-specific modules.

18. The computer readable media of claim 11 further comprising performing an end-to-end black box test on said multi-tier application.

19. The computer readable media of claim 11 wherein said multi-tier application environment comprises a utility data center.

20. The computer readable media of claim 11 wherein each of said plurality of tier-specific modules executes within a single tier of said multi-tier application environment.

21. A computer usable media comprising test output from a tier-specific module, wherein said tier-specific module performs a portion of a multi-tier application.
